(19) United States
(12) Patent Application Publication
(10) Pub. No.: US 2014/0250376 A1
(43) Pub. Date: Sep. 4, 2014

(54) SUMMARIZING AND NAVIGATING DATA USING COUNTING GRIDS

(71) Applicant: Microsoft Corporation, Redmond, WA (US)

(72) Inventors: Nebojsa Jojic, Bellevue, WA (US); Alessandro Perina, Seattle, WA (US); Andrzej Turski, Redmond, WA (US)

(73) Assignee: Microsoft Corporation, Redmond, WA (US)

(21) Appl. No.: 13/925,826

(22) Filed: Jun. 25, 2013

Related U.S. Application Data
(60) Provisional application No. 61/772,503, filed on Mar. 4, 2013.

(51) Int. Cl. G06F 17/21

(52) U.S. Cl. CPC G06F 17/212
USPC 715/273

(57) ABSTRACT

A browsable counting grid may be created that allows users to browse a document corpus through a visual/spatial interface. The counting grid may be created in a way that allows documents to be spatially organized by their subject matter, based on the words contained in the documents. The browsable counting grid may have various features that facilitate the user's navigation of a document corpus.

### CROSS-REFERENCE TO RELATED CASES

This case claims priority to U.S. Provisional Patent Application No. 61/772,503, filed Mar. 4, 2013, entitled “Summarizing and Navigating Data Using Counting Grids.”

### BACKGROUND

Users may want to find information in a corpus of documents. To assist users in finding documents, there is often reason to organize the documents in a way that makes browsing of the documents convenient for the user.

### SUMMARY

A browsable counting grid may be created that allows users to browse a document corpus through a visual/spatial interface. The counting grid may be created in a way that allows documents to be spatially organized by their subject matter, based on the words contained in the documents. Thus, the counting grid tends to show, in spatial proximity to each other, those words that tend to appear together in documents. “Words” in this case is not limited to literal text words, but may be understood more generally to include discernible video features, audio features, or any other identifiable feature of any type of content item. In this way, the counting grid can be used to organize not only text items, but also other types of content such as still images, video, audio, people's contact information, social network posts, etc. or multimodal content where documents contain different types of features.

The browsable counting grid may have various features that facilitate the user's navigation of a document corpus. For example, the user may be able to click on a location in the interface, thereby causing the system to show the user a set of documents that contain words found in that region. The user may be able to zoom in on a region of the counting grid, thereby revealing additional detail about the words that are associated with a particular region of the grid. Different colors may be used on the browsable counting grid to indicating information such as geographic or temporal proximity. User may be able to insert content into the counting grid, which a system may incorporate into the grid by further refining the placement of words and documents in the grid.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a flow diagram of an example process of creating and a grid to organize information.

FIG. 2 is a flow diagram of a part of an example counting grid.

FIG. 3 is a block diagram of an example browsable counting grid.

FIG. 4 is a block diagram of an example relationship between componential counting grids.

FIG. 5 is a block diagram of images from an example data set and an example visualization of certain words in counting grid locations.

FIG. 6 is a block diagram of an example counting grid geometry.

FIG. 7 is a block diagram of accuracy results on an example data set.

FIG. 8 is a block diagram of example results on a particular example dataset.

FIG. 9 is a block diagram of an example model at different stages of embedding.

FIG. 10 is a block diagram of example results of a particular comparison.

FIG. 11 is a block diagram of average error rates as functions of the percentage of several ranked lists considered for retrieval.

FIG. 12 is a block diagram of example components that may be used in connection with implementations of the subject matter described herein.

### DETAILED DESCRIPTION

With the vast amount of information available in electronic form, a problem that arises is to organize the information in a way that makes it easy for users to find what they are looking for. Traditional search engines allow users to find documents that are associated with text strings. More recently, search engines have been developed that allow users to search for other types of documents on non-text features—e.g., users can search for images based on visual features or based on similarity to other images. Some information-locating paradigms are based on the “browsing” model—e.g., organizing the information according to some criteria and allowing the user to look through the organized information.

The subject matter herein provides a browsable counting grid, in which space is used as a metaphor for subject matter organization of documents. Documents (which may include not only text documents, but also still images, video, audio, etc.) are placed on a grid. Documents that have similar subject matter (as indicated by overlapping content features, such as having textual words in common) tend to be placed in spatial proximity to each other on the grid. Each location on the grid is associated with words (or features) that appear in a corpus of documents, and a document is mapped to a region containing locations that contain a relatively large number of words in the document. For example, if the words “whale,” “dolphin,” and “shark” appear near each other in the grid, then an article on marine life is likely to be affined to a (compact) area covering the locations of those words. Other articles on marine life are likely to contain similar sets of words, so those articles are likely to be affined to an overlapping region. In this way, documents with similar subject matter tend to cluster together spatially, based on the assumption that documents that contain similar sets of words are likely to have to do with similar subject matter. The way in which the grid is constructed allows words that tend to appear in the same document to be placed near each other on the grid, and the documents are assigned to regions so that the words they share appear in the overlap This results in strides in the grid where the topic of slowly evolves, e.g. from marine life in deep ocean to marine life in the reef areas of the ocean, to the topics regarding reef protection, more general human pollution and environment and so on. In this way, the grid uses spatial proximity as a working metaphor for subject matter proximity.

In order to use the grid, the user uses a touch screen, pointing device, or other input device to move spatially through the grid. The user sees words that have been clustered together based on an analysis that is described below. Words that very strongly affine with a particular location may be shown in bolder or larger print than words that affine more weakly with a location. The user may zoom in on a particular location, thereby allowing the user to see a smaller spatial region of the grid, while seeing the less-strongly-affining words that might not have been visible at higher zoom levels. When the user identifies a spatial region of the grid (e.g., by clicking on a region, or by drawing a box around a region), the user may be shown a list of documents that are associated with that location (i.e., the documents which were mapped to regions near the focus point). In this way, the grid allows the user to browse documents not by predetermined subject matter categories, but by subject matter as organically determined from the overlap of words in documents.

As the CG (counting grid) and CCG (componential counting grid) models result in mapping documents to different areas of the grid, this layout can be used to either directly show multiple interesting document at once, or as an initial layout to be refined to accommodate varying sizes of the documents, keeping their initial spatial relationships relatively intact. This document layout may be particularly useful in arranging news stories in a newspaper-like format, especially on large scrollable panes. In this application of counting grids, the grid is used in the process of selection of top documents and their arrangement for easy visual scanning over related stories and consumptions of the ones of interest, either in one contained region with related topics, or across various spots in the entire grid in order to sample a diversity of topics.

The grid may be created in any manner, but in one example it is created as follows. An N×N matrix is created, and a corpus of documents is scanned to determine what words appear in that corpus. Words may then be randomly assigned to locations in the grid, with each location potentially containing multiple words and each word appearing in multiple locations. The documents are then assigned to regions in the grid based on which words the documents contain, and based on where those words are distributed in the grid. For example, if the words “whale,” “dolphin,” and “shark” happen to appear near each other on the grid, then a document on marine life that contains those words may be assigned to a region encompassing those words. If the words “plankton,” “algae,” and “krill” (also relating to marine life) appear near each other (but in some region of the grid that is distant from “whale,” “dolphin,” and “shark,” then the document may be assigned to one of these regions depending on which set of words is more strongly associated with the document. For example, if the word “whale” appears more times than “plankton,” then the document may be assigned a location near the “whale,” “dolphin,” and “shark” words, even though the region containing “plankton” might have been a plausible second choice. In one example, documents may be assigned to more than one region.

Since words may be assigned to the grid at random, the initial assignment of documents to the grid may be seemingly disordered. However, based on the assignment of documents to the grid, the word placement in the grid may be recalculated. Experiments show that, over approximately 70-80 iterations of this process, the placements of words on the grid tends to converge and become stable. Moreover, the convergent, stable placement of words on the grid tends to create strong subject matter affinities for specific regions on the grid. The affinities themselves may create sparseness in the grid, so the creation of the grid may be done in a way that penalizes sparseness, in order to encourage the algorithm to spread out words throughout the entire grid.

The interface that shows the grid may have various types of features. In one example, users may be able to add content such as images or documents to the grid. A person (or, at least, the attributes associated with a person) may be considered a type of content, so a user may be able to place people within the grid. Additionally, certain information is associated with colors on the grid—e.g., information on the grid that is close in time to the current time, or that is close in geographic proximity to the current user, might be indicated by certain colors, thereby allowing color to serve as an indication of geographic or temporal proximity.

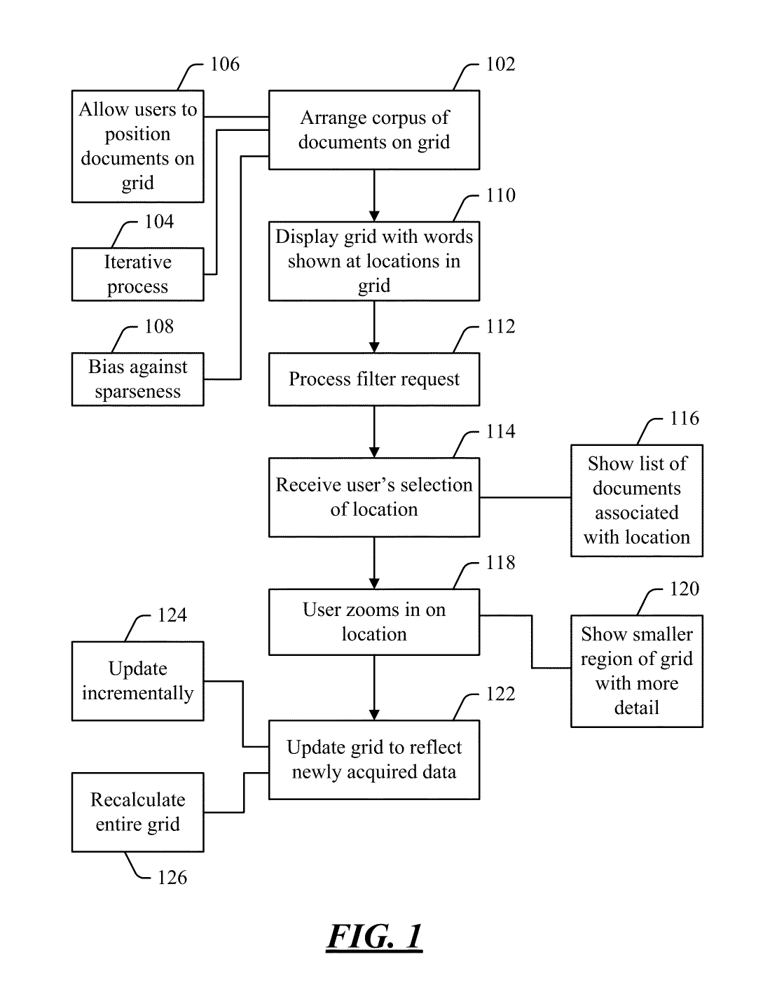

Turning now to FIG. 1, FIG. 1 shows an example process in which a grid is created and used in order to organize and present information. Using some corpus of documents (e.g., all news stories from a particular source in a given period of time), the corpus is analyzed in order to determine what words appear in the corpus. Those words are then arranged on a grid, and the documents in the corpus are placed on the grid (at 102). The placement of the documents on the grid is done in a way that fits each document to a location that contains words in the document. For example, if a document contains one hundred distinct words, and one location on the grid allows a defined window size to encompass two words in the document, and another location on the grid allows a defined window size to encompass three words in the document, then the document may be placed in the location that encompasses three words. Documents are fitted to the grid in this manner. Since the initial placement of words on the grid may be random, the documents may not fit their initial placement particularly aptly. Thus, the grid may be further refined in an iterative process (block 104). In this iterative process, once the documents are placed on the grid, the position of words on the grid is recalculated by positioning the words near the documents in which they frequently appear. The documents are then fitted to the new placement of words. Experiments show that this iterative process converges on a placement of words after approximately 70-80 iterations. The iterative process may contain a statistical bias against empty space (block 108), thereby encouraging the placement of documents on a grid to spread out. (As noted above, at some point after the grid has been calculated, users may place documents on a grid (block 106), thereby providing for user refinement of the grid.)

One the grid has been created, the grid may be displayed to a user, with the words being shown at particular locations (block 110). (The figures below show examples of how this display may look.) When the grid is shown to the user, the user may indicate a filtering request (block 112). For example, the user may enter a specific term, thereby allowing the display of the grid to be altered in a way that highlights words associated with documents that contain the user's specified term.

At 114, the user may select a location on the grid, and this selection may be received. For example, the user may use a pointing device to point to a particular location on the grid, or may draw a box around a particular location on the grid. Choosing a location on the grid may result in the user's being shown a list of documents that correspond to the chosen location (block 116).

At 118, the user may zoom in on a chosen location. The zooming action may result in the user's being shown a smaller region of the grid, but in additional detail (block 120). For example, words that were not made visible prior to the zoom may be made visible.

At some point in time, new documents may be added to the grid. The grid may then be updated to reflect the new documents (block 122). The updating may be done incrementally (block 124), or, in another example, the entire grid may be periodically recalculated (block 126).

### Overview 1

Described is a new interaction strategy for browsing documents comprising text and images. The browser represents a collection of documents as a grid of key words with varying font sizes that indicate the words' weights. The grid is computed using the counting grid model, so that each document approximately matches in its word usage the word weight distribution in some window (6×6 in our experiments) in the grid. In comparison to other document embedding approaches, this strategy leads to denser packing of documents and higher relatedness of nearby documents: The two documents that map to overlapping windows literally share the words found in the overlap. This leads to smooth thematic shifts that can provide connections among distant topics on the grid. The images are embedded into the appropriate locations in the grid, so that a mouse over any location can invoke a pop-up of the images mapped nearby. Once the user locks on an interesting spot in the grid, the summaries of the actual documents that mapped in the vicinity are listed for selection. In this document browser the arrangement of related words and themes on the grid naturally guides the user's attention to topics of interest. For an illustration, there is described and demonstrated a browser of four months of CNN news.

### Introduction 1

Summarizing, visualizing and browsing text corpora are important problems in computer-human interaction. As the data becomes more massive, ambiguous or conflicting, it may become hard for people to glean insights from it. To help the users, researchers have developed several visual analytics tools facilitating the analysis of such corpora. Through interactive exploration users are able to analyze and make sense of complex datasets, a process referred to as sensemaking.

There is described a new approach to browsing documents comprising of text and images, e.g. news stories on the web, social media, special interest web sites, etc. The browsing through documents is based on the exploration of the hidden variable of the on the counting grid (CG) generative model, which has recently been used for a variety of tasks related to regression and classification. The counting grid model represents the space of possible documents as a grid of word counts. Each individual document is mapped to a window into this grid so that the tally of these counts approximately matches the word counts in the document. The grid can vary in size, and so can the window. As the documents are allowed to be mapped with overlap, in order to maximize the likelihood of the data, the learning algorithm has to map similar documents to nearby locations in the grid, so that the words that the two documents share appear in the grid positions in the overlap of the corresponding windows. This leads to a compact representation where the theme of the documents smoothly varies across the grid, achieving a higher density of packing than previous embedding approaches (e.g. Egypt unrest news are placed close to other stories about Arab Spring, with Libya taking another distinct location in that area of the CG; nearby are stories about oil prices, and near these are more stories about the markets and economy, near which are stories referring to Fed's Bernanke, near which are stories about congress and the President, which, in a counting grid defined on a torus may loop back to Libya through military themes.) To provide natural means of summarization and browsing of the documents, a CG representation based only on the most frequent words in each position is rendered. The images from each document are embedded into the appropriate locations in the counting grid, so that they can pop up when the user focuses on a particular area of the grid (e.g. by mouse over). This provides the user with both a global and local perspective on the underlying set of documents and their relationships, without observing directly the underlying documents, but rather the CG model's representation of the document space. Once the user locks on an interesting spot in the grid, the summaries of the actual documents that mapped in the vicinity are listed for selection. This idea leads to an intuitive document browser that is especially well suited to touch devices, where moving a cursor is the most natural interaction modality, while typing is particularly difficult. Additionally, the interface assists the user in discovering documents of interest without having to define a particular target and associated keywords first: The arrangement of related words and themes on the grid naturally guides the user's attention to topics of interest.

### Counting Grids (CGS)

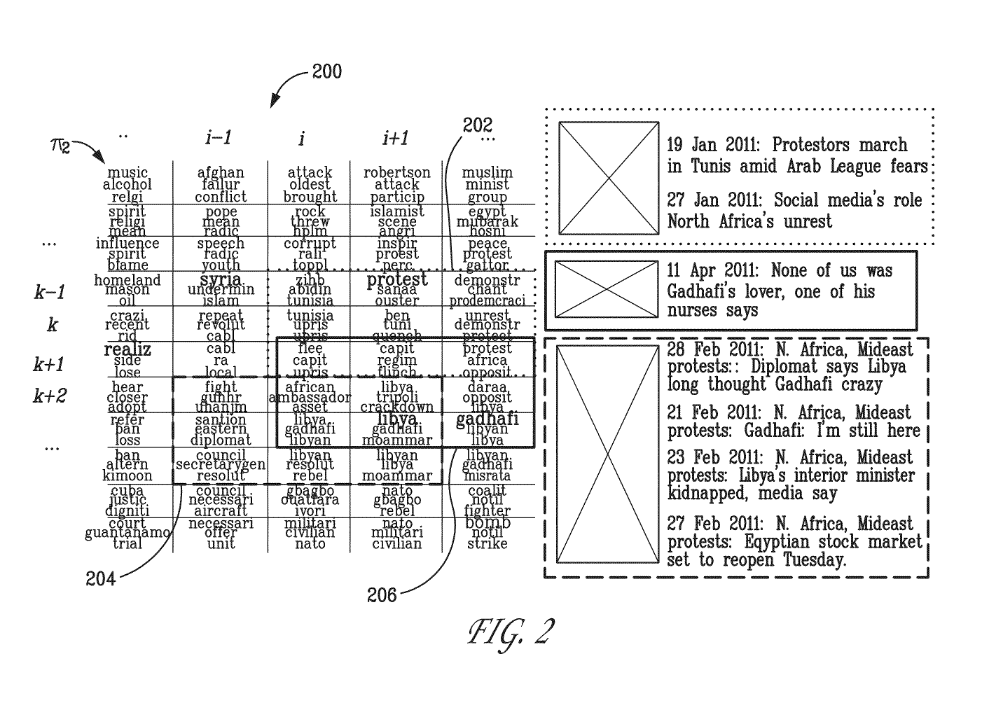

FIG. 2 shows a part of a counting grid 200 trained on the news stories. Three windows 202, 204, and 206 are highlighted along with seven stories that mapped there. Line patterns (solid, dotted, and dashed) indicates the mapping. The movement through the grid captures the spread of the Arab Spring in North Africa, and the subsequent UN reaction.

The counting grid comprises a set of discrete locations indexed by l in a map of arbitrary dimensions (30×30 to 40×40 2D torus grids in examples here). A part of a counting grid is illustrated in FIG. 1. Each location contains a different set of weights for the Z words in the vocabulary (Z=10000 here). The weight of the z-th word at location l is denoted by π_{z,l} and the weights add up to one, Σₗπ_{z,l}=1. Thus it is a probability distribution over words and defines the local word usage proportions. (These weights are partially illustrated in FIG. 2 using font size variation, but showing only the top 3 words at each location.) A document has its own word usage counts c_{z} and the assumption of the counting grid model is that this word usage pattern is well represented at some location k in the grid in the following way: When a window of a certain size is placed at location k in the CG, and the CG weights are averaged across N CG locations in the window Wₖ to obtain

$${h}_{z} = \frac{1}{N} {\sum }_{𝓁 ∈ {W}_{k}} {π}_{z , 𝓁} ,$$

then this distribution is approximately proportional to the observed document counts h_{z}∝c_{z}. In other words, approximately the same words in the same proportions are used in the document and in its corresponding counting grid window Wₖ. The window size 6×6, and thus N=36 was used in the experiments described herein, but due to space limitations 3×3 windows were used in FIG. 2.

The KL distance may be used as the actual measure of the agreement between the word distributions in the document and the CG window, both when documents are mapped to CG windows, as well as when CG distributions π_{z,l} are estimated so as to most compactly capture a set of documents in this sense.

The CG estimation algorithm starts with a random initialization which gives all words roughly equal weights everywhere. The subsequent iterations (re)map the documents to the windows in the grid and rearrange words to match the weights currently seen in the grid. In each iteration, after the mapping, the grid weights at each location are re-estimated to match the counts of the mapped document words. It was found that the algorithm converged in 70-80 iterations, which sums up to minutes for summarizing months of news on a single standard PC. As this EM algorithm is prone to local minima, the final grid will depend on the random initialization, and the neighborhood relationships for mapped documents may change from one run of the EM to the next. However, as shown in the supp. material, the grids qualitatively always appeared very similar, and some of the more salient similarity relationships were captured by all the runs (e.g. the Arab Spring news that referred to multiple different countries with very different unfolding of events are always grouped nearby). More importantly, a majority of the neighborhood relationships make sense from a human perspective and thus the mapping gels the documents together into logical, slowly evolving themes. As discussed below, this helps guide one's visual attention to the subject of interest. As the algorithm optimizes the likelihood of the data, all resources (grid locations) can be used, and the packing is much denser than in the previous embedding approaches, thus occasionally squishing themes together even though no documents map to their interface. Arugably, it is a small price to pay for high real estate utilization and, for the most part, intuitive arrangement of themes.

### Multimodal CG Display and Browsing

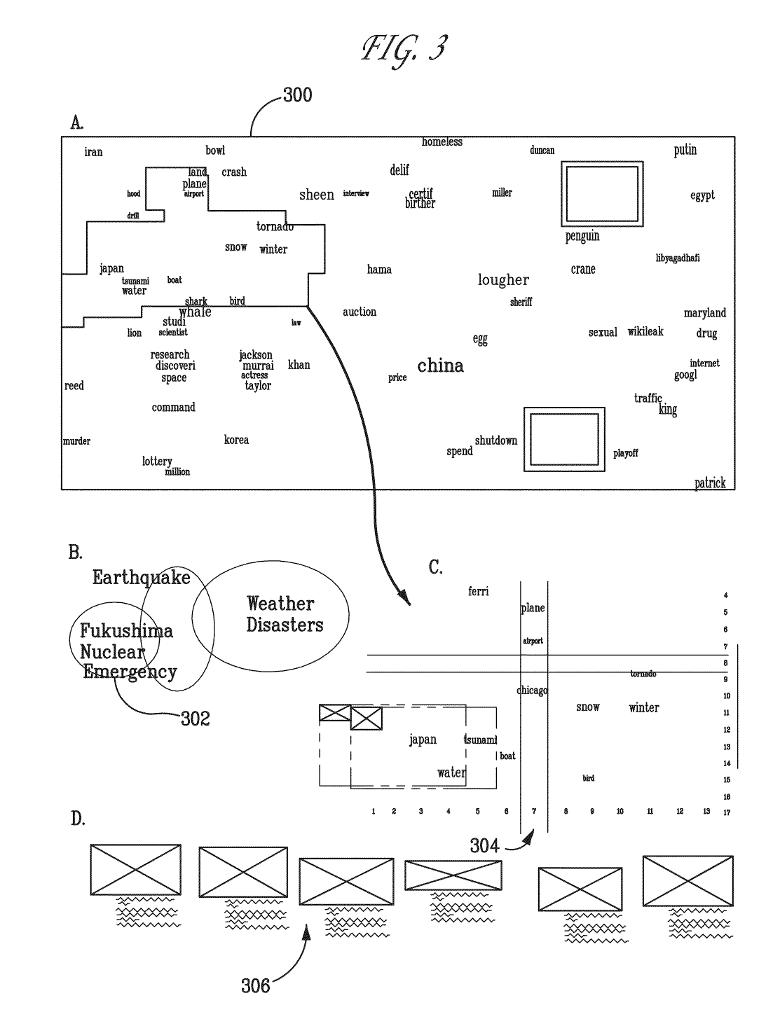

FIG. 3 shows a browsable counting grid 300. A. The text and image representation of the grid are combined with emphasis on text. In two locations images are brought into the foreground. The grid is defined on a torus (with left matching the right and the top continuing at the bottom). Various theme drifts are visible, e.g. the japan-tsunami-water-whale-study-scientist-research-development-space-shuttle-nasa-command-navy semicircle on the left, or regions 302 and 304, which captures the various disasters from the period. The preprocessing of the words reduced them to their roots and also made other standard alterations used in text analysis, but the unaltered words can be shown instead. Region 302 shows images mapped in the highlighted area. Region 304 shows more of the top words in the highlighted area, and an illustration of how the images were embedded: As each document maps onto a window, the images from the document go to a location in the window (top left in the illustration to avoid clutter, but the middle of the window in actual implementation to provide more natural alignment). Region 306 shows some of the news that mapped to the highlighted area. The area of interest can be selected by cursor hover and the news can be recalled by a simple click.

To browse a collection of multimodal documents comprising both text and images, a CG model is first fitted to the corpus, and then embed the images into appropriate locations of the grid, so that each image is placed in the grid position in the center of the window to which the source document was mapped (FIG. 3). This results in a grid of images of the same size as the word counting grid with a rough semantic alignment: In each image's vicinity the grid locations have high weights on the words related to the image. Obviously, there is now a multitude of possible approaches to visualizing this embedding in a way that explores the two modalities in concert. To show the image embedding, one can simply show a tiling of images (e.g. based on the 30×30 CG). In locations where multiple images are mapped, one can pick one at random (as in the experiments described herein), or the one that was used in multiple documents, or the one selected by a computer vision algorithm. In addition, the images mapped to the same location can slowly cycle. To visualize the CG word weights π_{z,l} in each grid location, there is shown the top k words (k=3 in the experiments described herein) using the font size to indicate the word weight. In the browser, one can switch between the two representations, or show them one on top of the other with a certain level of transparency (FIG. 3). In addition, a pointer (a mouse cursor, fingertip on touch devices, etc.) can be used to force the switch between images and words locally in a window of a certain size (5×5 in the experiments described herein). In this way the user can base their exploration primarily on one modality, bringing the other modality to the fore by hovering over the grid parts of interest. In particular, the word representation is particularly useful in drawing the user's attention across related themes to the point of interest. As the user naturally moves the pointer toward their eyes' focal point the pointer uncovers images underneath to further refine the user's understanding of the grid content. At any point, the user can stop and indicate (e.g. by a click) their desire to see the source documents that mapped in this region. Two ways of uncovering the images in the region where the user hovers may be implemented. In the first approach, the words in the grid locations around the cursor are highlighted and the images from these locations are shown next to the highlighted area. In the second approach, one may simply replace the area around the cursor with images. As the embedding is based on overlapping windows, in both cases it is possible that some of the images that pop up this way are related to the themes slightly outside the highlighted area. Once the user is used to this it becomes imperceptible as the matching words (or images) are never far and slight movements of the pointer help lock onto the topic of interest. To further indicate the smooth nature of the mapping, experiments have been performed with varying sizes and intensities of images that pop up. For example, in FIG. 3 the central image of the highlight is of larger size and it slightly overlaps the 6 images around it, which themselves are larger and overlap even more the images around them, creating an impression of the underlying images popping out from the words, with relationship being approximate but smooth, inviting the user to move the cursor around.

Although the CG model glues the documents together based on the vocabulary overlap that can contain a large number of different words, to a human observer, just the top words for each location seem to provide enough insight into the thematic shifts in the grid. The grid in FIG. 3 gels the disaster stories together due to their common vocabulary (e.g. disaster, response, emergency, etc.), but in the browser most of that shared vocabulary is overtaken by the words that get high weight in individual locations (earthquake, tornado, airplane, crash, snow, storm, etc.). The human mind easily detects connections among these and does not have to observe all of the “glue” that linked these topics together. It appears that the CG visualization seems to stimulate the user's own associations and memory and guides the user to the target even if they did not start with a particular target in mind: A look at a salient Japan and earthquake keywords creates an association with local weather disasters, reminding the user that they were following an airplane crash story. This association process is guided by CG's own ‘associations’ so that the spot in the grid is found quickly. Further interaction with the grid to invoke visual stimulus increases the pace of news discovery.

To accommodate for variable display sizes and corpora diversities, one can train a hierarchy of CG models of various sizes, where model of one size is initialized by an upsampled version of the model of the smaller size. In this multi-granular approach, the user can zoom in and out of any part of the grid. Window size choice provides the tradeoff between finer document overlaps and the computational complexity of the CG estimation, but for the CNN news stories at least, the latter was not a limiting factor.

### Discussion

The approach described herein provides some important advantages over the existing visualization/browsing/search approaches. The 10×10 grid website (http://www.tenbyten.org/10×10.html) also arranges images into a grid. But, the placement of images is not optimized so that the nearby locations capture related stories. Previous methods for spatially embedding documents produce sparse representations (e.g. “The Galaxy of News”), which are only locally browsable, whereas the counting grids use the screen real estate much more efficiently. In addition, the approach described herein allows embedding of multiple modalities. Various galaxy approaches required that the user interact with the embedding through the statistical model, manipulating its parameters and/or weights, which may be impenetrable to the user, thus requiring a laborious guess and check strategy. This issue is still a subject of research in HCI. In contrast, the CG parameters (grid size and the scope of overlap, i.e. the window size), are more intuitive, and multi-granular approaches may remove the cause for parameter selection altogether.

The CG visualization reminds one of tag clouds, visual representations that indicate frequency of word usage within textual content. Google News Cloud (http://fserb.com.br/newscloud/index.html) sorts words alphabetically, varying the font based on the relevance. If a word is selected other similar words are highlighted. But the links among the complex documents that combine a variety of words are not evident. Other tools (e.g., Toronto Sun, Washington Post websites) cluster words based on co-occurrence or proximity and then position the words belonging to the same clusters near each other and use color to emphasize the structure. Still, the words are not spatially embedded within a cluster, and so only cluster hopping can be performed, in contrast with smooth thematic drifts found in CGs. For the most part, the tag clouds are designed to provide a useful and visually pleasing summary of the news, rather than a two-dimensional densely organized multimodal browsing index which CG provides. In terms of providing a means for traversing an organization of news, the method described herein shares some similarities with Newsmaps (http://newsmap.jp/) which use a hierarchical representation, a tree. But the traversal paths descend along the branches of the tree while CGs often capture many different directions of thematic drifts which can loop back.

### Counting Grid Creation Techniques

Techniques follow that may be used in the process of creating the counting grids described above.

### Overview 2

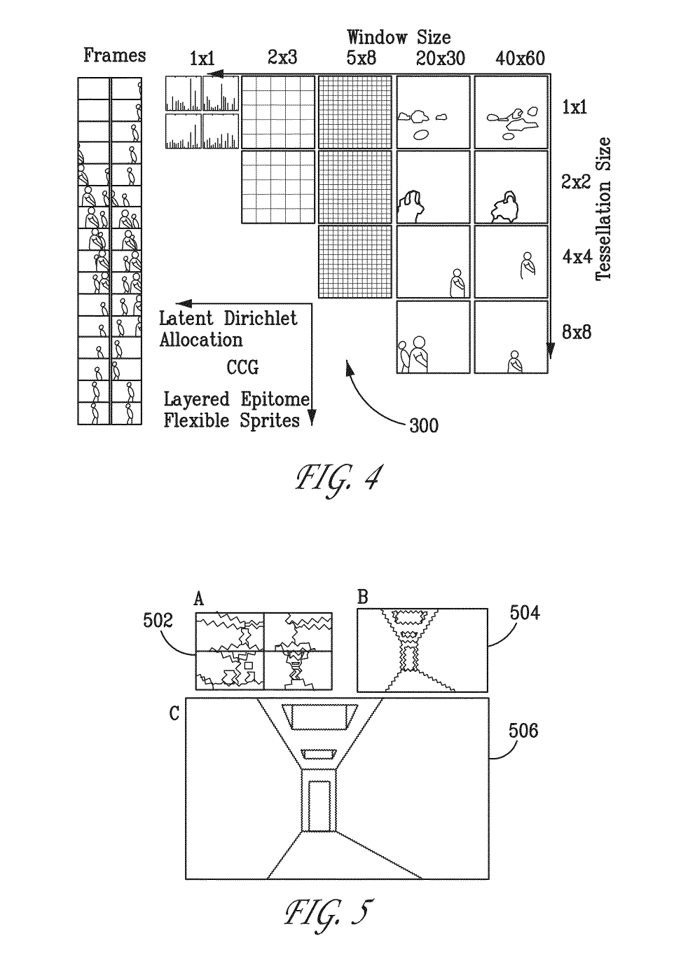

FIG. 4 shows a relationship of componential counting grids 300 with (layered) Epitomes/Flexible Sprites and Topic models.

FIG. 5 shows gray-level images 502 from four classes of the SenseCam dataset (Office, Atrium, Corridor, Lounge) and visualizations 504 and 506 of the top words in each counting grid location. In visualization 506 in each location the texton is shown that corresponds to the peak of the distribution (M) at the location, while in visualization 504 these textons are overlapped by as much as the patches were overlapping during feature extraction process, and then are averaged to create a clearer visual representation.

Recently, the counting grid (CG) model was developed to represent each input image as a point in a large grid of feature (SIFT, color, high level feature) counts. This latent point is a corner of a window of grid points which are all uniformly combined to form feature counts that match the (normalized) feature counts in the image. As bag of words model with a spatial layout in the latent space, the CG model has superior handling of field of view changes in comparison to other bag of word models, but with the price of being essentially a mixture, mapping the entire scene to a single window in the grid. Here, one can extend the model so that each input image is represented by multiple latent locations, rather than just one (FIG. 5). In this way, one can make a substantially more flexible admixture model—the componential counting grid (CCG)—which can break each image into its parts and map them to separate windows in a counting grid allowing for smooth topic transitions. Furthermore, the CCG model creates connections between two popular generative modeling strategies in computer vision, previously seen as very different: By varying the image tessellation and window size of CCG, one can get a variety of models among which the latent Dirichlet allocation as well as flexible sprites/layered epitomes are at two ends, or rather corners FIG. 4, of the spectrum. In each of these corners, substantial research effort has been invested to refine and apply these basic approaches, but it turns out that the CCG models at neither end of the spectrum tend to perform best in the experiments described herein.

### Introduction 2

The most basic counting grid (CG) model represents each input image as a point in a large grid of feature (SIFT, color, high level feature) counts. This latent point is a corner of a window of grid points which are all uniformly combined to form feature counts that match the (normalized) feature counts in the image. Thus, the CG model strikes an unusual compromise between modeling spatial layout of features and simply representing image features as a bag of words where feature layout is completely sacrificed. The spatial layout is indeed forgone in the representation of any single image, as the model is simply concerned with modeling the feature histogram. But the spatial layout is present in the counting grid itself, which, by being trained on a large number of individual image histograms, recovers some spatial layout characteristics of the image collection to the extent that allows correlations among feature counts to be captured. For example, in a collection of images of a scene taken by a camera with a field of view that is insufficient to cover the entire scene, each image will capture different scene parts.

Interestingly, slight movement of the camera produce correlated changes in feature counts, as certain features on one side of the view disappear, and others appear on the other side. The resulting bags of features show correlations that directly fit the CG model. Ignoring the spatial layout in the image frees the model from having to align individual image locations, allowing for geometric deformations, while the grid itself reconstructs some of the 2D spatial layout that is used for modeling feature count correlations.

As is demonstrated in FIG. 5, arranging counts on a topology that allows feature sharing through windowing can have representational advantages beyond this surprising possibility of panoramic scene reconstruction from bags of features.

Counting Grids have been recently used in the context of scene classification and video analysis.

FIG. 6 show counting grid geometry 602, Componential Counting Grid (CCG) generative model 604, CCGs generative process 606, and Illustration 608 of U^{w}_{In}; (in this case Iₙ=(1; 1) and W=3×3) and Λ^{w}_{θ} relative to the particular θ shown in part b).

The model can be extended so that each input image is represented by multiple latent locations in CG, rather than just one (FIG. 6). In this way, one can make a substantially more flexible admixture model—the componential counting grid (CCG)—and as discussed below, one can create connections between two popular generative modeling strategies in computer vision, previously seen as very different: By varying the image tessellation and window size of CCG, one can get a variety of models among which the Latent Dirichlet Allocation as well as flexible sprites/layered are epitomes. In this generative model organization, the models at neither end of the spectrum tend to perform best in the experiments.

Componential Counting Grids and layered epitomes/flexible sprites. The relationship between CCG and CG models is similar to the relationship between the basic epitome model, which models the entire input as being mapped to one single area in the latent space, and the layered version of epitome, as well as flexible sprite models, which both allow each image to be mapped to multiple sources. While the former may be suitable to modeling texture and large scenes, the latter allows segmentation of each image into parts that are mapped separately. Through admixing of CG locations, CCG model is also a multi-part or -object model, but as opposed to layered epitomes and flexible sprites, which preserve the spatial layout of features both in the latent space and in the image itself, the CCG model, like its CG predecessor, still models images as bags of words, recreating only as much of spatial layout in the counting grid as necessary for capturing count correlations.

Componential Counting Grids and topic models. The original counting grid model shares its focus on modeling image feature counts (rather than feature layouts) with another category of generative models the “topic models”, such as latent Dirichlet allocation (LDA). However, neither model is a generalization of another. The CG model is essentially a mixture model, assuming only one source for all features in the bag, while the LDA model is an admixture model that allows mixing of multiple topics to explain a single bag. By using large windows to collate many grid distributions from a large grid, CG model can be a very large mixture of sources without overtraining, as these sources are highly correlated: Small shifts in the grid change the window distribution only slightly. LDA model does not have this benefit, and thus has to deal with a smaller number of topics to avoid overtraining. Topic mixing cannot quite appropriately represent feature correlations due to translational camera motion.

The CCG model, however, is a generalization of LDA, as it does allow multiple sources for each bag, in a mathematically identical way as LDA. But, the equivalent of LDA topics are windows in a counting grid, which allows the model to have a very large number of topics that are highly related, as shift in the grid only slightly refines any topic.

Popular generative models for vision as part of the “CCG spectrum”. In computer vision, instead of forming a single bag of words out of one image, separate bags are typically extracted from a uniform P×Q rectangular tessellation of the image. The basic CG model does not simply model the different image quadrants separately. Instead all sections are still mapped to the same CG, and each image still has a single point in CG as its latent variable. But, the corresponding window is tessellated in the same way as the image, and the feature histograms from corresponding rectangular segments are supposed to match. Even with as coarse tessellations as 2×2, training CG on image patches can result in panoramic reconstruction similar to that of the epitome model which entirely preserves the spatial layout.

Tessellated version of CCG is just as straightforward an extension as was the corresponding extension of CG, and so in the mathematical description below there is a focus only on the basic non-tessellated CG model. In FIG. 4, though, there is shown a variety of CCG models one can obtain by varying the tessellation and the window size for the mapping. (The window size does not have to match the size of the input image). Images used in training contain multiple objects and a background captured from a moving field of view, and a subset of frames is shown in the image. Due to visualization advantages for this illustration, all models were trained using discretized colors rather than SIFT features, and they all have roughly the same capacity—the number of independent topics that can be created in the allotted space without overlapping the windows. This means that counting grids created with smaller windows have to be proportionally smaller, but for better visualization all grids have been enlarged to the same size. Window overlaps create smooth interpolations among topics that compensate for camera motion. When 1×1 windows are used, there is no sharing of grid distributions among topics, and the model reduces to LDA shown in the corner with its histograms for its topics. As there is no sharing, the spatial arrangement of four topics onto the 2×2 grid has no meaning or value. Layered epitomes or flexible sprites are another extreme where both the window size and the tessellation match the resolution of input images, but the CCG models with as coarse a tessellation as 8×8 already look indistinguishable from epitome/flexible sprite results.

The video sequence features prominently a man and a women dressed in white clothing (see the Frames in FIG. 4). While LDA color model will obviously confuse the white elements of the background with these foreground objects, the model with full tessellation has to learn multiple versions of each person to capture the scale changes due to their motion at an angle with the motion of the camera. The intermediate tessellations and window size provide more interesting tradeoffs. For example, one can see a generalized representation of each object, where some of the original spatial layout of features is recovered, but the allowed rearrangement of the features in the tessellation segments compensates for scale. When the model is forced to simplify further, through appropriate choice of window and tessellation size, the two persons dressed in white are generalized into a single object (though it may occur twice in one image).

While this illustration reinforces the naturally good fit of CCG models to images of scenes with multiple moving objects taken by a camera with a moving field of view, the applicability of the CCG models hardly stops there. FIG. 5 illustrates the value of computing a grid of features in a very different context, where one large grid is computed from all images from 4 of the 32 class wearable camera dataset. Each image was represented by a single bag of features (1×1 tessellation) and the counting grid is computed using 38×50 windows. A total of 200 feature centers were used, and in each spot in the grid, only the peak of the histogram is shown. The model tends to break up each bag into more topics, and instead of reflecting a panoramic reconstruction, the grid now models smaller scene parts, such as vertical and horizontal edges found in windows and building walls that the subject sees in his office and elsewhere. The choice of edges placed close together shows that the model makes sure that a window into the grid captures an appropriate feature mix found in some of the images in the training set. In multiple places in the grid one sees that when the window is moved the orientation of the edges changes slightly and in concert. Thus, in this case the CG real-estate and window overlapping strategy was often used to model rotation, rather translation. Finally, one can show the CCG model trained on daily bag of (English) words representing four months of CNN news, to demonstrate that even in case of much higher-level features, which do not immediately appear to have a natural spatial embedding, the CCG still arranges features in a logical (2D) order. Thus the combination of feature, window and tessellation choices can yield a variety of adaptations to the data in which the use of the grid that the windows share yields to often surprising ways of capturing smooth incremental changes in the data.

Next the basic CG model is mathematically described, which bears a lot of similarity with representations in FIG. 4, but as opposed to these, it does not model multiple scene parts as mapped to different parts of the CG, but would rather have to try to learn all foreground-background combinations. Then, the CCG model, and its learning algorithm, are formally derived. Finally, the CCG performance on various image and multimodal datasets is demonstrated.

### Counting Grids and Componential Counting Grids

Counting Grids. Formally, the basic 2-D Counting Grid π_{i,z} is a set of normalized counts of words/features indexed by z on the 2-dimensional discrete grid indexed by i=(iₜ, i_{y}) where each i_{d}ε[1 . . . E_{d}] and E=(Eₓ, E_{y}) describes the extent of the counting grid. Since it is a grid of distributions, Σ_{z}π_{i,z}=1 everywhere on the grid. Each bag of words/features, is represented by a list of word {w^{t}}ₜ₌₁^{T}; it can be assumed that all the samples have N words and each word with wₙ^{t} takes a value between 1 and Z.

Counting Grids assume that each bags follow a feature distribution found somewhere in the counting grid; In particular, using windows of dimensions W=(W₁,W_{y}), a bag can be generated by first averaging all counts in the window Wᵢ starting at 2-dimensional grid location i and extending in each direction d by W_{d} grid positions to form the histogram

$${h}_{\{ i , z \}} = \frac{1}{{Π}_{d} {W}_{d}} {\sum }_{j ∈ {W}_{i}} {π}_{j , z} ,$$

and then generating a set of features in the bag. In other words, the position of the window i in the grid is a latent variable given which the probability of the bag can be written as

$$p ( \{ w \} \vert i ) = {Π}_{n} {h}_{i , z} ( {w}_{n} ) = \frac{1}{{Π}_{d} {w}_{d}} {Π}_{n} ( ( {\sum }_{j ∈ {W}_{i}} {π}_{j , z} ( {w}_{n} ) ) ,$$

An example of Counting Grid geometry is shown in FIG. 6.

Relaxing the terminology, E and W are referred to as, respectively, the counting grid and the window size. The ratio of the two volumes, κ, is called the capacity of the model in terms of an equivalent number of topics, as this is how many non-overlapping windows can be fit onto the grid. Finally, Wᵢ indicates the particular window placed at location i.

Componential Counting Grids. As seen in the previous section, counting grids generate words from a feature distribution in a window W, placed at location i in the grid. Locations close in the grid generate similar features. As the window moves on the grid, some new features appear while others are dropped. Learning the model that can generate this way produces panoramic reconstructions in the CG (as seen in FIG. 5) or, at a higher level, captures (or infers new) spatial or topological relationships among features (i.e., features of the sea are close to sand, buildings are often over a street). On the other hand in standard componential models, each feature can be generated by a different “process” or “topic.” Tehse models capture feature co-occurrence (e.g., sands often comes with sea), and by breaking the bag into topics can potentially segment the image into parts.

Componential counting grids (CCG) get the best of both worlds: using the counting grid embedding through window overlapping, they can recover spatial layout, but like componential models they can also explain the bags as generated from multiple positions in the grid (called components), explaining away the foreground and clutter, or discovering parts that can be combinatorially combined in the image collection (e.g., grass, horse, ball, athlete, to explain different sports that may be created mixing these topics).

Therefore, in a CCG generative model each bag is generated by mixing several windows in the grid following the location distribution θ. More precisely, each word wₙ can be generated from a different window, placed at location lₙ, but the choice of the window follows the same prior distributions θₗ for all words. Within the window at location lₙ the word comes from a particular grid location kₙ, and from that grid distribution the word is assumed to have been generated.

The Bayesian network is illustrated in FIG. 5 and it defines the following joint probability distribution

P=Π_{t,n}τₗ_{ₙ}Σₖ_{ₙ}p(wₙ|kₙ,π)·p(kₙ|lₙ)·p(lₙ|θ)·p(θ|α) (1)

where p(wₙ=z|kₙ,π)=πₖ_{ₙ}(z) is a multinomial over the word indices. p(kₙ|lₙ)=Uₗ_{ₙ}^{W} is a distribution over the Counting Grid, equal to

$$( \frac{1}{Π w} )$$

in the window Wₗ_{ₙ} and 0 elsewhere, p(lₙ|θ)=θₗ is a prior distribution over the windows location, and p(θ|α)=Dir (θ; α) is a dirichlet distribution of parameters α.

The generative process (FIG. 5c), is the following:
1. Sample a multinomial over the locations θ˜α
2. For each of the N words wₙ
a) Choose a at location lₙ˜θ for a window W
b) Choose a location within Wₗ_{ₙ}; kₙ˜Uₗ_{ₙ}^{W}
c) Choose a word wₙ from πₖ_{ₙ}

Since the posterior distribution p(k, l, θ|w, π, α) is intractable for exact inference, the model was learned using variational inference.

By introducing the posterior distributions q, and approximating the true posterior as q^{t} (k, l, θ)=q^{t}(θ)·Πₙ(q^{t}(kₙ)·q^{t}(lₙ)) one can write the negative free energy [symbol] , and use the iterative variational EM algorithm to optimize it.

[symbol]

=Σ_{t,n}Σₗ_{ₙ}Σₖ_{ₙ}q^{t}(kₙ)·q^{t}(lₙ)·log πₖ_{ₙ}(wₙ)·Uₗ_{ₙ}^{W}(kₙ)·θₗ·p(θ|α)− [symbol] (q) (2)

where [symbol] (q) is the entropy of the posterior. Minimization of Eq. 2 reduces in the following update rules:

q^{t}(kₙ)˜πₖ_{ₙ}(wₙ)·exp(Σₗ_{ₙ}q^{t}(lₙ)·log Uₗ_{ₙ}^{W}(kₙ)) (3)

q^{t}(lₙ)˜θₗ_{ₙ}^{t}·exp(Σₖ_{ₙ}_{=α}q^{t}(kₙ)·log Uₗ_{ₙ}^{W}(kₙ)) (4)

θₗ^{t}˜αₗ−1+Σₙq^{t}(lₙ) (5)

πₖ(z)˜ΣₜΣₙq^{t}(kₙ)^{[w}^{ₙ}^{=z]} (6)

where [wₙ=z] is an indicator function, equal to 1 when wₙ is equal to z.

The minimization procedure described by Eqs. 3-6 can be carried out efficiently in θ(N logN) time, however some simple mathematical manipulations of Eq. 1 can yield to a speed up. In fact, from Eq. 2 one can marginalize lₙ for fast update q^{t}(kₙ)

$$\begin{matrix}P = {Π}_{t , n} {Σ}_{{l}_{n}} {Σ}_{{k}_{n}} p ( {w}_{n} \vert {k}_{n} ) \cdot p ( {k}_{n} \vert {l}_{n} ) \cdot p ( {l}_{n} \vert θ ) \cdot p ( θ \vert α ) \\ = {Π}_{t , n} {Σ}_{{l}_{n}} {Σ}_{{k}_{n}} {π}_{{k}_{n}} ( {w}_{n} ) \cdot {U}_{{l}_{n}}^{W} ( {k}_{n} ) \cdot p ( {l}_{n} \vert θ ) \cdot p ( θ \vert α ) \\ = {Π}_{t , n} {Σ}_{{k}_{n}} {π}_{{k}_{n}} ( {w}_{n} ) \cdot ( {Σ}_{{l}_{n}} {U}_{{l}_{n}}^{W} ( {k}_{n} ) \cdot {θ}_{{l}_{n}} ) \cdot p ( θ \vert α ) \\ = {Π}_{t , n} {Σ}_{{k}_{n }} p ( {w}_{n} \vert {k}_{n} , π ) \cdot {Λ}_{θ}^{W} \cdot p ( θ \vert α )\end{matrix} \qquad ( 7 )$$

where Λ_{θ}^{W} is equal to the convolution of U^{W} with θ, which can be efficiently carried out using ffts or cumulative sums. The update for q(k) becomes

q^{t}(kₙ)˜πₖ_{ₙ}(wₙ)·Λ_{θ}^{W} (8)

In the same way, one can marginalize kₙ

$$\begin{matrix}P = {Π}_{t , n} {Σ}_{{l}_{n}} {θ}_{{l}_{n}} \cdot ( {Σ}_{{k}_{n}} {U}_{{l}_{n}}^{W} ( {k}_{n} ) \cdot {π}_{{k}_{n}} ( {w}_{n} ) ) \cdot p ( θ \vert α ) \\ = {Π}_{t , n} {Σ}_{{l}_{n}} {θ}_{{l}_{n}} \cdot {h}_{{l}_{n}} ( {w}_{n} ) \cdot p ( θ \vert α )\end{matrix} \qquad ( 9 )$$

to obtain the new update for q^{t}(lₙ)

q^{t}(lₙ)˜hₗ_{ₙ}(wₙ)·θₗ_{ₙ}^{t} (10)

where hₗ is the feature distribution in a window centered in l, which can be efficiently computed in linear time using cumulative sums.

This last updates highlight the relationships between CCGs and LDA. CCGs can be thought as an LDA model whose topics live on the space defined by the counting grids geometry.

The most similar generative model to CCG comes from the statistic community. Dunson et al. worked on sources positioned in a plane at real-valued locations, with the idea that sources within a radius would be combined to produce topics in an LDA-like model. They used an expensive sampling algorithm that aimed at moving the sources in the plane and determining the circular window size. The grid placement of sources of CCG yields much more efficient algorithms and denser packing. In addition, as illustrated above, CCG model can be run with various tessellations efficiently making it especially useful in vision applications.

### Experiments

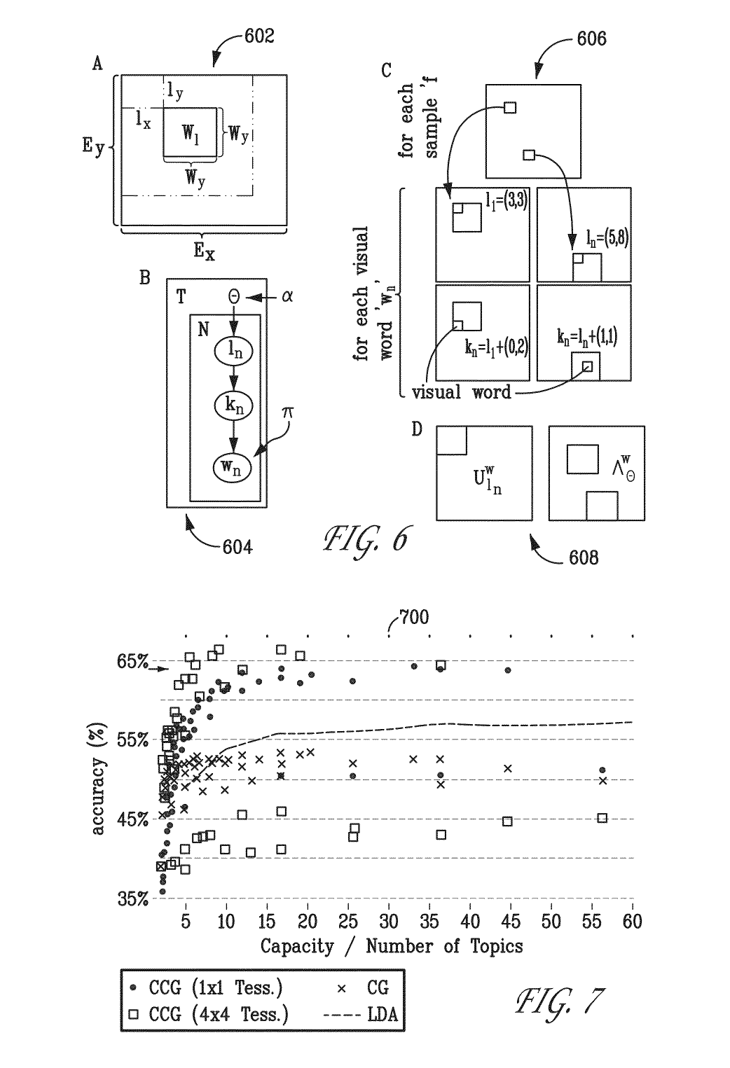

FIG. 7 shows results 700 on SenseCam (Mean results over 5 repetitions). As the same κ can be obtained with different choice of E and W, multiple results may be reported for the some values of κ. For CCGs Accuracies lower than 45% are all obtained with E<=[10,10].

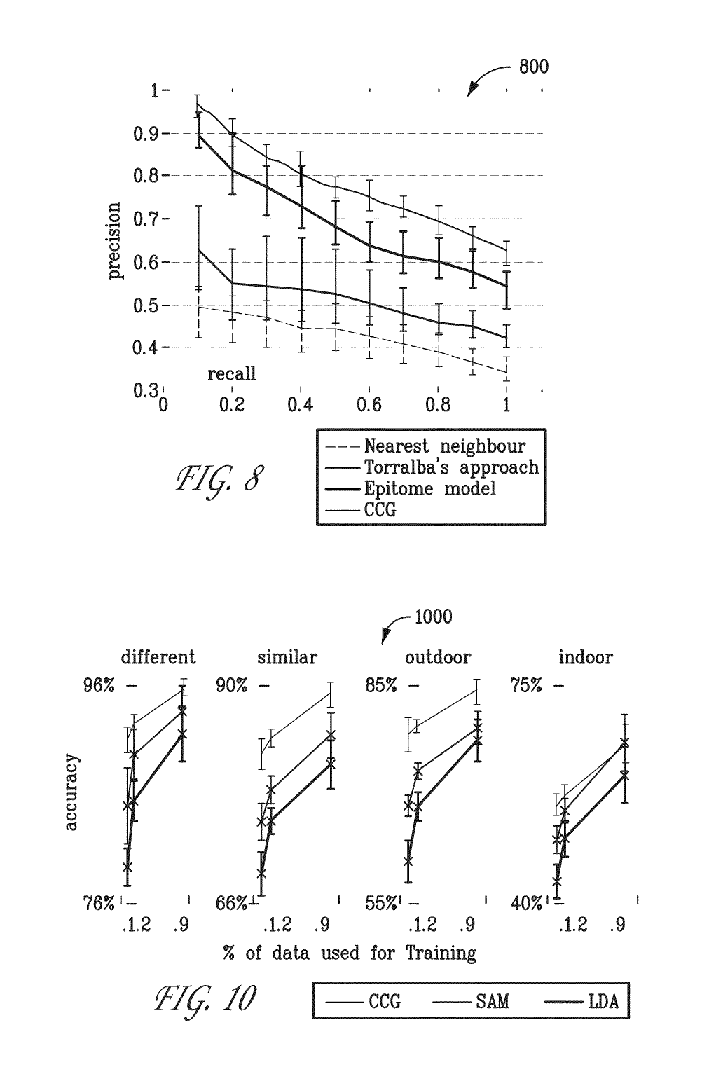

FIG. 8 shows results 800 on Torralba sequences. Our approach strongly outperforms Nearest Neighbor, and. No tessellation have been used for this test.

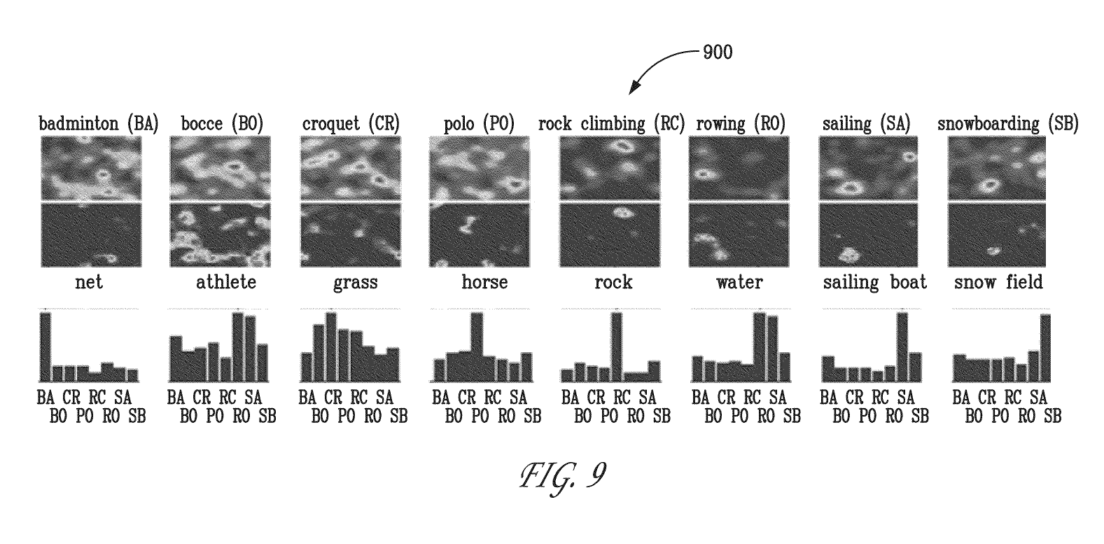

FIG. 9 shows results 900 of a particular comparison. The three rows in this comparison are discussed below.

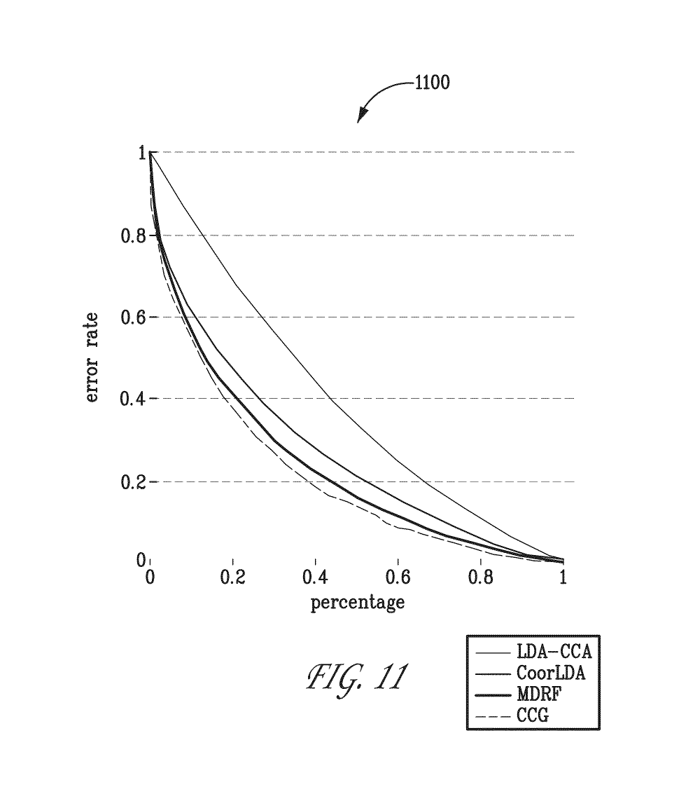

FIG. 10. Shows results 1000 of a comparison with SAM, as more particularly discussed below.

FIG. 11. shows average error rate 1100 as a function of the percentage of the ranked list considered for retrieval. Curves closer to the axes represents better performances. CCGs outperforms LDA, CorrLDA and sets a new state of the art. AUC for the method discussed herein is 22:90±0:7, while for is 23:14±1:49 (Smaller values indicate better performance)

In all the experiments as visual words SIFT features were used, extracted from 16×16 patches spaced 8 pixels apart, clustered in Z=200 visual words. In each task, unless specified, the dataset author's training/testing/validation partition and protocol was employed; if not available 10% of the training data was used as a validation set.

CGs of various complexities were considered with grid size E=[2, 3, . . . , 10, 15, 20, . . . , 40] and window size W=[2, 4, 6, . . . ] but limiting the tests only to the combinations with capacity

$$κ = \frac{{E}_{x} \cdot {E}_{y}}{{W}_{x} \cdot {W}_{y}} between 1.5 and T / 2 ,$$

where T is the number of training samples. In addition to single bag models (1×1 tesselation, in some tests, the experiment was also repeated using 2×2 and 4×4 tesselations.)

Place Classification on SenseCam: Recently a 32-classes dataset has been proposed. This dataset is a subset of the whole visual input of a subject who wore a wearable camera for few weeks. Images in the dataset exhibit dramatic viewing angle, scale, illumination variations and a lot of foreground objects, and clutter.

CCGs were compared with LDA and CGs, learning a model per class and test samples were assigned to the class that gives the lowest free energy. The capacity κ is roughly equivalent to the number of LDA topics as it represents the number of independent windows that they can be fit in the grid; the results were compared using this parallelism. Results are shown in FIG. 7: CCG outperforms LDA and CGs across various choices of model parameters. CCG breaks the image into parts and, like regular CGs, maps these onto a bigger real estate, trying to recover their panoramic nature, by laying out the features into a 2D window and stitching overlapping windows. This fits both the panoramic and componential qualities of the data acquired by a wearable camera.

Moderate tessellation (4×4) significantly helped, except in very small grid/window sizes (the streak of red boxes below all results), where the model reduces itself to very low resolution feature epitome. Setting E>10 stabilizes the model which then reaches the best results across all the complexities.

The overall accuracy after cross-evaluation is 64%±1.7 strongly outperforming recent advances in scene recognition and setting the new state-of-the-art by a large margin.

Scene Recognition. CCGs were also tested on a place dataset. In addition to the comparison with the original method there, a comparison was also made with Epitomes, as epitomic location recognition was, among recognition applications of epitome, one of the most successful. The trick was to use low resolution epitome with each low res image location represented by a histogram of features (thus corresponding to CCG with tessellation size and window size being equal). Results are presented in FIG. 8; the improvement is significant and once again, CCGs set a new state-of-the-art.

The UIUC Sports dataset was also considered: This dataset is particularly challenging as composing elements and objects must be identified and understood in order to classify the event. For this task, a single CCGs pooling was learned on all the classes together (E=[40, 50, . . . , 90] and W=[2, 4, 6, 8]), and then training set's θ^{t} was used as feature to learn a discriminative classifier (Use was made of SVM with histogram intersection kernel). The rationale here is that different classes share some elements, like “water” for sailing and rowing, but also will have peculiar elements that distinguish them. This is visible in FIG. 9 where in the first row there is depicted p(i|θ,c)=Σₜ_{_{c}}θᵢ^{t}^{_{c}}, where the sum is carried out on separately on the samples of each class. After learning a model, the textual annotations available for this dataset are embedded, simply iterating the M-step using textual words as observations. In the second row of FIG. 9 it it shown where some selected words are embedded in the grid.

The variation in spatial layout of the objects here was sufficient to render tessellations beyond 1×1 unnecessary: They do not improve classification results (but did provide a basis to increase the window size).

CCGs was also compared with SAM. SAM is characterized by the same hierarchical nature of LDA, but it represents bags using directional distributions on a spherical manifold modeling features frequency, presence and absence. The model captures fine-grained semantic structure and perform better when small semantic distinctions are important. CCGs maps documents on a probabilistic simplex (e.g., θ) and for W>1 can be thought as an LDA model whose topics, h_{i,z}, are much finer as computed from overlapping windows (see also Eq. 10). Following an experimental set-up, the 13-Scenes dataset was divided into four separate 4-classes problems: different (including livingroom, MITstreet, CALsuburb, and MITopencountry), similar (MITinsidecity, MITstreet, CALsuburb, MITtallbuilding), outdoor (MITcoast, MITforest, MITmountain, MITopencountry), and indoor (bedroom, kitchen, livingroom, PARoffice), ordered by their classification difficulty. Like for each dataset, a single model was learned using all the data and then a logistic regressor was trained on θ^{t} varying the percentage of data using for training in the set {10%, 20%, 90%}. Results are reported in FIG. 10; CCGs outperform LDA and SAM and shows that also its “topics” capture fine grained variations in the data.

Multimodal Data: the Wikipedia Picture of the Day dataset (WPoD) was considered. This dataset is composed 2000 pictures described by a short text paragraph which goes well beyond a simple depiction of the appearance of the objects present in the image. The task is multi-modal image retrieval: given a text query, one may aim to find images that are most relevant to it.

To accomplish this, a model (E=[40, 50, . . . , 90] and W=[2, 4, 6, 8]) was learned using the visual words of the training data {w^{t,V}}, thus obtaining θ^{t}, πᵢ^{V}. Then, keeping θ^{t} fixed and iterating the M-step, the textual words {w^{t,T}} were embedded, obtaining πᵢ^{W}. For each test sample the values of θ^{t,V} and θ^{t,W} were inferred respectively from πᵢ^{V} and πᵢ^{W} and KL-divergences between θ's were used to compute the retrieval scores. The data were split in 10 folds. Results are illustrated in FIG. 11. Although this simple procedure was used without directly training a multimodal model, the result is on par (or better) than the state-of-the-art.

### Conclusions

The componential counting grid (CCG) model can be seen as a generalization of both LDA and template-basedmodels such as flexible sprites. As opposed to the basic CG model, it allows for source (object, part) admixing in a single bag of words. In addition, by partially decoupling the feature layout modeling in the image from the layout modeling in the latent space (the grid of feature distributions as in the CG model), it empowers the modeler to strike balance between layout following and transformation invariance in substantially different and more diverse ways than these previous models, simply by varying the tessellation and the mapping window size (which is typically not linked to the original image size).

Keeping the capacity (equivalent number of independent topics) fixed, the increase in window size incurs the proportional increase in the computational cost, but provides for smoother reconstruction in the spatial layout: The model actually increases the number of topics, but these topics are gradual refinements of each other, as captured by overlapping windows on the grid. The tessellation guides the rough positioning of the features from different image quadrants. In the experiments described herein it was found that the basic LDA and flexible sprites-like models, which are at opposite corners of the model organization by tessellation and window size, underperform the CCG models from somewhere in the middle of the triangle illustrated on the toy data in FIG. 4. A number of refinements previously added to generative models can be added to CCG, e.g., the mask model akin to the ones used by flexible sprites and layered epitomes, modeling the spatial layout changes in tessellation segments as in the spring lattice CG model, exotic priors and added hierarchies as in LDA-based models, or as in any generative model, addition of other hidden variables that relate to other modalities or higher-level variables.

### Example Operation of Browsable Counting Grid

FIG. 2, described above, shows a browsable counting grid. The following is a description of an example operation of the browsable counting grid.

The browsable counting grid may be displayed on a display device, such as a computer monitor, smart phone monitor, etc. The monitor may be a touch screen, or there may be some other mechanism (e.g., a pointing device such as a mouse or touch pad) that allows a user to interact with the content on the screen. In the case of a touch screen, the user may simply point and click by touching the screen. Regardless of the mechanism that is used for pointing, the user may point to a location on the screen. When the user points, a window (e.g., a rectangular window) surrounding the location to which the user has pointed may be highlighted to reflect the size of the region to which a document is mapped, and thus showing which words would be present in documents mapped to this particular location. In addition, images associated with documents could be shown in the vicinity of the document's mapping location, or next to selected document's summary. FIG. 2 shows three such rectangles: one near the upper right corner of the counting grid, and one near the lower right corner of the counting grid. Each of these rectangular windows represents what a user would see if the user pointed to a location inside the window.

If the user clicks on a location on the screen a list of documents that map to that location may be shown. For example, if the user were pointing to a location within the lower-left highlighted window in FIG. 2, and then the user clicked on the pointed-to location (e.g., by clicking a mouse or touch pad button, or by tapping on a touch screen), then a pop-up dialog box may be shown that contains a list of documents that contain the words within the window the surrounds the pointed-to location (which would retrieve documents that were mapped there, as the criterion for mapping location selection is that the document's words tend to be contained in the mapped (rectangular) region).

In one example, a filter box may be provided, into which a user can enter one or more filtering terms. When such a filter is used, those documents that contain the filtering term may be selected, and the view of the grid that is shown to the user may be altered to reflect only those documents that satisfy the filter. For example, if the user filters documents on a term like “shrimp”, then the view of the browsable counting grid that is shown may be changed so that only those words contained in documents that contain the word “shrimp” are shown, thereby allowing the user to see clusters of documents that contain the word(s) that is (are) used as filtering criteria. Additionally, the browsable counting grid may have a zoom feature that allows the user to zoom in on a specific region of the counting grid in order to focus on particular subject matter.

### Example Variation on Counting Grid Creation Technique

Although the counting grid for a corpus of documents may be created in an manner, an example technique for creating the counting grid is described above. The following material is an example variation on that technique.

Inasmuch as a counting grid is build on an N×M matrix, there may be reason to try to fill up all (or nearly all) of the cells in the matrix, since blank space in the matrix may translate to screen real estate that is not helping the user to navigate the corpus of documents. One way to avoid such unused space is to start with a grid in which words are placed randomly on the grid. Documents in the corpus are then mapped to the grid. Since the placement of words in the grid is initially more-or-less random noise, documents are not likely to map very strongly to any position, but small perturbations in the random, noisy structure are likely to cause documents to affine to some place in the grid. Using this placement of documents, words in the grid are re-mapped, and the cycle is repeated, mapping documents to the new grid (i.e., the grid with words that have been resituated relative to the previous iteration). This cycle may be repeated an arbitrary number of times and, as noted above, experiments show that the grid tends to converge on a placement after approximately 70-80 iterations.

The variation on this process that tends to fill the empty space is to bias the weighting algorithm in favor of empty space upon each iteration. If documents are placed on the grid solely based on how well they fit, then over several iterations they tend to cluster, leaving space in between the clusters. Upon each iteration, the documents are placed on the grid by scoring various placements, and choosing the placement with the highest score. Thus, in order to encourage documents to spread into empty spaces, the scoring algorithm may be biased in a way that increases the score for placing a document in unoccupied space (even if that space is not otherwise the optimal fit for the document). Over a number of iterations, the documents may converge on a placement in the grid that takes into account both the goal of fitting documents based on their mapping to the words in the counting grid, and the goal of filling up empty space in the grid.

### Example Implementation Environment

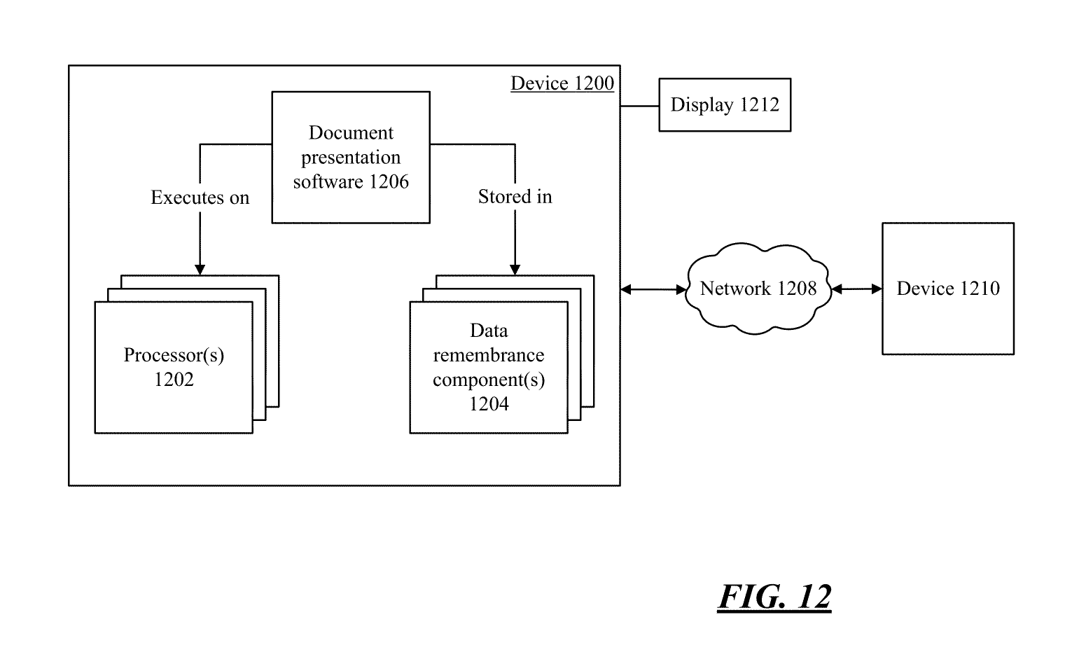

FIG. 12 shows an example environment in which aspects of the subject matter described herein may be deployed.

Device 1200 includes one or more processors 1202 and one or more data remembrance components 1204. Processor(s) 1202 are typically microprocessors, such as those found in a personal desktop or laptop computer, a server, a handheld computer, or another kind of computing device. Data remembrance component(s) 1204 are components that are capable of storing data for either the short or long term. Examples of data remembrance component(s) 1204 include hard disks, removable disks (including optical and magnetic disks), volatile and non-volatile random-access memory (RAM), read-only memory (ROM), flash memory, magnetic tape, etc. Data remembrance component(s) are examples of computer-readable storage media (or device-readable storage media). Device 1200 may comprise, or be associated with, display 1212, which may be a cathode ray tube (CRT) monitor, a liquid crystal display (LCD) monitor, or any other type of monitor. As another example, device 1200 may be a smart phone, tablet, or other type of device.

Software may be stored in the data remembrance component(s) 1204, and may execute on the one or more processor(s) 1202. An example of such software is document presentation software 1206, which may implement some or all of the functionality described above in connection with FIGS. 1-11, although any type of software could be used. Software 1206 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 12. A smart phone loaded with apps is another non-limiting example that typifies the scenario depicted in FIG. 12. However, the subject matter described herein is not limited to these examples.

The subject matter described herein can be implemented as software that is stored in one or more of the data remembrance component(s) 1204 and that executes on one or more of the processor(s) 1202. As another example, the subject matter can be implemented as instructions that are stored on one or more computer-readable (or device-readable) media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable media, regardless of whether all of the instructions happen to be on the same medium.

Computer-readable media (or device-readable media) includes, at least, two types of computer-readable (or device-readable) media, namely computer storage media and communication media. Likewise, device-readable media includes, at least, two types of device-readable media, namely device storage media and communication media.

Computer storage media (or device storage media) includes volatile and non-volatile, removable and non-removable media implemented in any method or technology for storage of information such as computer readable instructions, data structures, program modules, or other data. Computer storage media (and device storage media) includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that may be used to store information for access by a computer or other type of device.

In contrast, communication media may embody computer readable instructions, data structures, program modules, or other data in a modulated data signal, such as a carrier wave, or other transmission mechanism. As defined herein, computer storage media does not include communication media. Likewise, device storage media does not include communication media.

Additionally, any acts described herein (whether or not shown in a diagram) may be performed by a processor (e.g., one or more of processors 1202) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, device 1200 may be communicatively connected to one or more other devices through network 1208. Device 1210, which may be similar in structure to device 1200, is an example of a device that can be connected to device 1200, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A system for browsing a corpus of documents, the system comprising:
a memory;
a processor;
a counting grid creator that is stored in said memory, that executes on said processor, and that creates a counting grid from said corpus of documents in which each word that appears in said documents is mapped to a location on said counting grid, and in which documents are mapped to locations in said counting grid based on a correspondence between words in said documents and words in neighborhoods of said locations; and
a browsable document presenter that is stored in said memory, that executes on said processor, and that presents an interactive visual representation of said counting grid which is navigable by a user to allow the user to point to a location on said representation and to display sets of documents that map to a window around said location.

2. The system of claim 1, said browsable document presenter comprising a filtering mechanism that allows a user to filter documents in said corpus based on one or more criteria.

3. The system of claim 1, said counting grid creator biasing placement of documents on said counting grid in favor of unused spaces in said counting grid.

4. The system of claim 1, said browsable document presenter providing an interface for said user to add a document or other item to a location on said counting grid.

5. The system of claim 1, said browsable counting grid using color of said words in said counting grid or color of said documents to indicate geographic proximity of a topic to said user or temporal proximity of a subject of a document to a time at which said browsable counting grid is being used.

6. The system of claim 1, said system updating said browsable counting grid incrementally as new documents are placed on said browsable counting grid.

7. The system of claim 1, said system recalculating said browsable counting grid to reflect new documents to be placed on said browsable counting grid.

8. A device-readable storage medium that stores executable instructions for browsing a corpus of documents, the executable instructions, when executed by a device, causing the device to perform acts comprising:
creating a counting grid from said corpus of documents in which each word that appears in said documents is mapped to a location on said counting grid;
mapping said documents to locations in said counting grid based on a correspondence between words in said documents and words in neighborhoods of said locations; and
presenting an interactive visual representation of said counting grid which is navigable by a user to allow the user to point to a location on said representation and to display sets of documents that map to a window around said location.

9. The device-readable storage medium of claim 8, said acts further comprising:
receiving a filtering criterion from said user; and
filtering documents in said corpus based on said criterion.

10. The device-readable storage medium of claim 8, said creating of said counting grid comprising:
biasing placement of documents on said counting grid in favor of unused spaces in said counting grid.

11. The device-readable storage medium of claim 8, said acts further comprising:
providing an interface for said user to add a document or other item to a location on said counting grid.

12. The device-readable storage medium of claim 8, said acts further comprising:
using color of said words in said counting grid or color of said documents to indicate geographic proximity of a topic to said user or temporal proximity of a subject of a document to a time at which said browsable counting grid is being used.

13. The device-readable storage medium of claim 8, said acts further comprising:
receiving a request to zoom in on a particular location in said counting grid; and
showing said user a region of said counting grid that is smaller than all of said counting grid, including making words visible to said user that are not visible when all of said counting grid is shown.

14. The device-readable storage medium of claim 8, said acts further comprising:
recalculating said browsable counting grid to reflect new documents to be placed on said browsable counting grid.

15. A method of browsing a corpus of documents, the method comprising:
using a processor to perform acts comprising:
creating a counting grid from said corpus of documents in which each word that appears in said documents is mapped to a location on said counting grid;
mapping said documents to locations in said counting grid based on a correspondence between words in said documents and words in neighborhoods of said locations; and
presenting an interactive visual representation of said counting grid which is navigable by a user to allow the user to point to a location on said representation and to display sets of documents that map to a window around said location.

16. The method of claim 15, said acts further comprising:
receiving a filtering criterion from said user; and
filtering documents in said corpus based on said criterion.

17. The method of claim 15, said creating of said counting grid comprising:
biasing placement of documents on said counting grid in favor of unused spaces in said counting grid.

18. The method of claim 15, said acts further comprising:
providing an interface for said user to add a document or other item to a location on said counting grid.

19. The method of claim 15, said acts further comprising:
using color of said words in said counting grid or color of said documents to indicate geographic proximity of a topic to said user or temporal proximity of a subject of a document to a time at which said browsable counting grid is being used.

20. The method of claim 15, said acts further comprising:
updating said browsable counting grid incrementally as new documents are placed on said browsable counting grid.
